(19) United States
(12) Patent Application Publication
(10) Pub. No.: US 2015/0104581 A1
(43) Pub. Date: Apr. 16, 2015

(54) FILTER UNIT, COATING APPARATUS, AND METHOD FOR PRODUCING COATING FILM

(71) Applicant: NITTO DENKO CORPORATION, Osaka (JP)

(72) Inventors: Makoto Komatsubara, Ibaraki-shi (JP); Hajime Michihira, Ibaraki-shi (JP); Masashi Miyake, Ibaraki-shi (JP)

(73) Assignee: NITTO DENKO CORPORATION, Osaka (JP)

(21) Appl. No.: 14/341,053

(22) Filed: Jul. 25, 2014

(30) Foreign Application Priority Data
Oct. 16, 2013 (JP) 2013-215357

(51) Int. Cl. B01D 35/02; B05C 5/02; B05C 11/10; B01D 35/30

(52) U.S. Cl. CPC B01D 35/02; B01D 35/30; B05C 5/0245; B05C 11/10
USPC 427/425; 210/436; 118/600

(57) ABSTRACT

A filter unit including a filter and a housing, in which the filter has an opening on one end side and filters a coating liquid from the outside to the inside of the filter, the housing has, on one end side, an inlet port of the coating liquid, and has, on the other end side, an outlet port of the coating liquid filtered by the filter, the filter is attached to the other end side of the housing so that the opening and the outlet port communicate with each other, and the housing has a release hole through which air is released, the release hole being formed at the other end outside the filter.

### CROSS-REFERENCE TO RELATED APPLICATION

This application claims priority to Japanese Patent Application No. 2013-215357, the disclosure of which is incorporated herein by reference in its entirety.

### BACKGROUND OF THE INVENTION

1. Field of the Invention

The present invention relates to a filter unit, a coating apparatus, and a method for producing a coating film.

2. Background Art

Conventionally, coating apparatuses for forming a coating film by coating a sheet with a coating liquid have been used. In such a coating apparatus, if foreign matter is mixed in the coating liquid, the quality of coating films to be obtained by coating deteriorates. Therefore, this coating apparatus generally includes a filter unit provided with a filter that filters the coating liquid and a housing that houses the filter, where the coating liquid is filtered using the filter unit, and the filtered coating liquid is applied to a sheet. Further, such a filter unit is configured, for example, so that both end sides of the filter are fixed within the housing, or while such both end sides are fixed as above, one of the end sides is fixed under pressure by a spring or the like.

However, in the coating apparatuses of this type, there are cases where the coating liquid with air bubbles entrained therein is introduced into the filter housing. In such a case, the coating liquid containing the air bubbles is applied to the sheet, after passing through the filter. When the coating liquid containing the air bubbles as above is applied to the sheet, a coating film with the air bubbles entrained therein is obtained, or a coating film having a thickness varied by the amount of the air bubbles from a desired value may possibly be obtained. Further, since members for fixing both ends of the filter are provided within the housing, air bubbles may be accumulated by these members hindering the flow of the air bubbles, which accumulation causes the air bubbles to coalesce with each other so as to grow, resulting in a possibility that a coating film to be obtained contains still larger air bubbles entrained therein.

Therefore, coating apparatuses provided with a filter unit capable of removing air bubbles in the filter unit have been proposed.

Proposed examples of the filter unit provided in such a coating apparatus include a filter unit arranged with its longitudinal direction extending in the vertical direction, in which a cylindrical filter having an opening at its lower end is fixed to the lower end side of a housing of the filter unit so that a coating liquid is introduced inside the filter from below, and a release hole through which air bubbles are released is formed on the upper end side so that, after the coating liquid is filtered from the inside to the outside of the filter, air bubbles in the filtered coating liquid are released through the release hole (see JP 2008-041791 A).

Proposed examples of the filter unit provided in such a coating apparatus also include a filter unit arranged with its longitudinal direction extending in the vertical direction, in which a cylindrical filter having an opening at its lower end is fixed to the lower end side of a housing, an inlet port through which a coating liquid is introduced is formed on the upper end side of a body (sidewall) of the housing, and a release hole for air bubbles is formed on the still upper end side of the inlet port, so that, while air bubbles are released through the release hole with the coating liquid flowing downwardly from the upper end side toward the lower end side, the coating liquid after being filtered from the outside to the inside of the filter is discharged from the lower end side of the housing (see JP 8(1996)-279461 A).

Such techniques enable air bubbles within the filter unit to be removed through the release hole while reducing the accumulation of air bubbles by fixing one end side of the filter.

### SUMMARY OF THE INVENTION

However, the filter housing as disclosed in JP 2008-041791 A removes the air bubbles from the coating liquid after being filtered by the filter, that is, the air bubbles are not removed from the coating liquid before being filtered. Therefore, the filter itself hinders the flow of air bubbles, and thus the air bubbles may possibly accumulate on the surface of the filter so as to grow. Further, the coating liquid in which the air bubbles are entrained is filtered, which makes the air bubbles in the coating liquid after being filtered very small. As a result, the removal of the air bubbles from the coating liquid may possibly be made difficult. Furthermore, the buoyancy of the air bubbles is reduced by being finely divided as above to that extent, which may make it difficult to cause the air bubbles to move upward to the release hole.

Further, in the filter housing as disclosed in JP 8(1996)-279461 A, the coating liquid moves from above to below, and therefore the air bubbles in the housing are pushed downward by the flow of the coating liquid, to which extent the removal of the air bubbles from the coating liquid may possibly be made difficult. Further, the upward flow of the air bubbles is hindered by the flow of the coating liquid toward a direction against the buoyancy of the air bubbles. As a result, the air bubbles accumulate, and it may possibly be made difficult to remove the air bubbles from the coating liquid.

In view of such problems, it is one object of the present invention to provide a filter unit capable of removing air bubbles more easily than in conventional techniques. Further, it is other objects of the present invention to provide a coating apparatus and a method for producing a coating film that are capable of applying a coating while removing air bubbles more easily than in conventional techniques, and capable of suppressing formation of a coating film with reduced quality.

A filter unit according to the present invention includes: a filter configured to filter a coating liquid to be applied to a sheet; and a housing configured to house the filter, wherein the filter has an opening on one end side, and is configured to filter the coating liquid from the outside to the inside of the filter, the housing has, on one end side, an inlet port through which the coating liquid is introduced, and has, on the other end side, an outlet port through which the coating liquid filtered by the filter is discharged, the filter is attached to the other end side of the housing so that the opening and the outlet port communicate with each other, and the housing has a release hole through which air is released, the release hole being formed on the other end side outside the filter.

According to such a configuration, the filter unit can be arranged so that the other end side of the housing is located above the one end side thereof, thereby exerting the following action. That is, the coating liquid introduced through the inlet port of the housing flows upward outside the filter within the housing. With this flow, the coating liquid after being filtered from the outside to the inside of the filter can be discharged through the outlet port of the housing, while air is moved to the other end side. At this time, the air moved to the other end side can be released through the release hole.

In this way, while the coating liquid moving upward is filtered by the filter from the outside to the inside, the air entrained in the coating liquid before being filtered can be released through the release hole by being pushed upward to the other end side due to the flow of the coating liquid and the specific gravity of the air that is smaller than that of the coating liquid, without being pushed downward so that the flow (buoyancy of the air) is hindered.

Accordingly, air bubbles are more easily removed than in conventional techniques.

Further, the coating apparatus according to the present invention includes: the aforementioned filter unit; and a coater configured to form a coating film by applying a coating liquid filtered by the filter unit to the sheet, wherein the filter unit is arranged so that the other end side of the housing is located above the one end side of the housing.

Such a configuration includes the filter unit arranged so that the other end side of the housing is located above the one end side thereof, and therefore enables the filtered coating liquid to be applied to the sheet while air bubbles are easily removed from the coating liquid.

Further, air entrainment or thickness variation from a desired value can be suppressed. Therefore, formation of a coating film with reduced quality can be suppressed.

Further, a method for producing a coating film of this embodiment includes: filtering a coating liquid by the filter unit; and forming a coating film by applying the coating liquid after being filtered to a sheet, using the aforementioned coating apparatus.

Such a configuration allows the filtration of the coating liquid by the filter unit arranged so that the other end side of the housing is located above the one end side thereof, and therefore enables the filtered coating liquid to be applied to the sheet while air bubbles are easily removed from the coating liquid.

This enables the filtered coating liquid to be applied to the sheet while air bubbles are easily removed from the coating liquid. Further, air entrainment or thickness variation from a desired value can be suppressed. Therefore, formation of a coating film with reduced quality can be suppressed.

### BRIEF DESCRIPTION OF THE DRAWINGS

FIG. 1 is a schematic configuration diagram of a coating apparatus provided with a filter unit according to one embodiment of the present invention.

FIG. 2 is a schematic perspective view of the filter unit of this embodiment.

FIG. 3 is a schematic cross sectional view of the filter unit of this embodiment.

FIG. 4 is a schematic front view, as seen from a first cover side, of the filter unit of this embodiment.

FIG. 5 is a schematic perspective view of the filter unit of this embodiment.

### DETAILED DESCRIPTION OF THE PREFERRED EMBODIMENT

Hereinafter, embodiments of a filter unit, a coating apparatus including the filter unit, and a method for producing a coating film, using the coating apparatus according to the present invention are described with reference to the drawings.

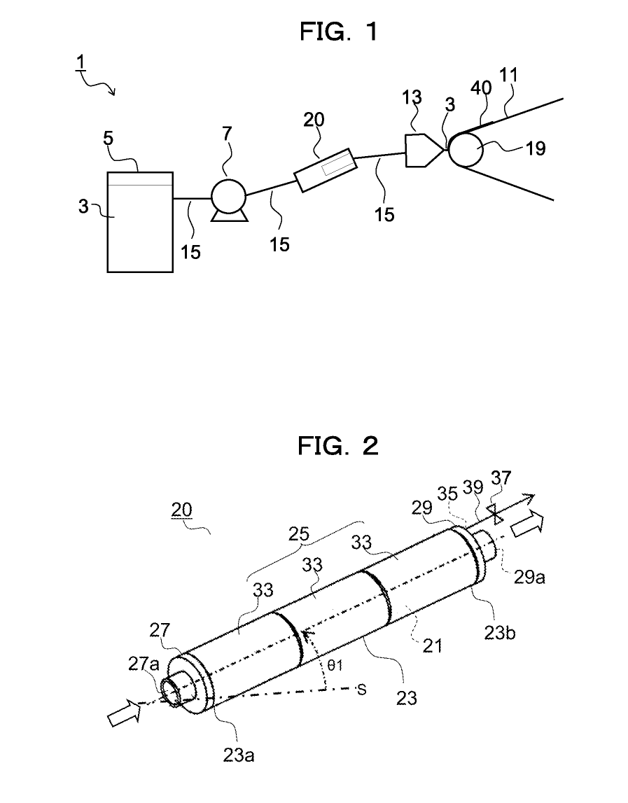

As shown in FIG. 1 and FIG. 2, a coating apparatus 1 of this embodiment includes a reservoir 5 that stores a coating liquid 3, a pump 7 as a liquid delivering part that delivers the coating liquid 3 from the reservoir 5 to the downstream side, a filter unit 20 that filters the coating liquid 3 delivered by the pump 7, a coater 13 that sequentially applies the coating liquid 3 filtered by the filter unit 20 to a sheet 11 having a strip shape that is relatively moving along the longitudinal direction toward the downstream side so as to form a coating film 40, conduits 15 that form moving paths of the coating liquid 3, and a supporting part 19 that supports the sheet 11. Further, the coating apparatus 1 includes a conduit 39 that forms a moving path of air bubbles (air) released from the filter unit 20, and a valve 37 provided on the conduit 39.

Examples of the coating liquid 3 include polymer solutions.

Further, the sheet 11 is configured to be coated with the coating liquid 3 (more specifically, the coating liquid 3 after being filtered) and to support it, and further to support the coating film 40 formed by curing of the coating liquid 3 after being applied onto the sheet 11. Examples of the sheet 11 include a resin film.

The reservoir 5 stores the coating liquid 3 to be applied to the sheet 11. Examples of the reservoir 5 include a tank made of metal.

The pump 7 delivers the coating liquid 3 stored in the reservoir 5 toward the downstream side to the filter unit 20. The pump 7 is configured to supply a necessary pressure for the coating liquid 3 to be filtered by the filter unit 20. Examples of the pump 7 include conventionally known pumps such as a gear pump and a diaphragm pump.

The coater 13 is configured to sequentially apply the coating liquid 3 filtered by the filter unit 20 to the sheet 11 having a strip shape that is relatively moving toward the downstream side with respect to the coater 13 while being supported by the supporting part 19 such as a roller. The coater 13 is constituted, for example, by a die coater.

The conduits 15 connect respective parts between the reservoir 5 and the pump 7, between the pump 7 and the filter unit 20, and between the filter unit 20 and the coater 13, so as to form paths in which the coating liquid 3 moves from the reservoir 5 to the filter unit 20 via the pump 7, and the coating liquid 3 after being filtered moves from the filter unit 20 to the coater 13.

Examples of such a conduit 15 include a tube formed into a tubular shape, for example, using a metal material, a composite material obtained by mixing a resin with metal, or a resin material.

The supporting part 19 supports the sheet 11 that is moving in the longitudinal direction from the opposite side of a port of the coater 13 through which the coating liquid 3 is discharged. Examples of the supporting part 19 to be used herein include a roller.

The filter unit 20 filters the coating liquid 3 delivered by the pump 7.

As shown in FIG. 2 to FIG. 5, the filter unit 20 includes a filter 21 that filters the coating liquid 3 to be applied to the sheet 11, and a housing 23 that houses the filter 21. The filter 21 has an opening 21ba on an end 21b side, and is configured to filter the coating liquid 3 from the outside to the inside of the filter 21. The housing 23 has, on one end 23a side, an inlet port 27a through which the coating liquid 3 is introduced, and has, on the other end 23b side, an outlet port 29a through which the coating liquid 3 filtered by the filter 21 is discharged. The filter 21 is attached to the other end 23b side of the housing 23 so that the opening 21ba and the outlet port 29a communicate with each other. A release hole 35 through which air is released is formed on the other end 23b side of the housing 23 outside the filter 21. Here, the phrase that the opening 21ba and the outlet port 29a communicate with each other means the coating liquid 3 after being filtered can pass through the opening 21ba and the outlet port 29a.

Further, the filter unit 20 is arranged so that the other end 23b side of the housing 23 is located above the one end 23a side thereof.

In the embodiments shown in FIG. 1 and FIG. 2, the housing 23 is arranged so as to be inclined obliquely upward from the one end 23a side toward the other end 23b side. Such arrangement of being inclined obliquely upward facilitates movement of the air bubbles toward the release hole 35.

An inclined angle θ1 of the filter unit 20 with respect to an imaginary plane S parallel to the horizontal plane is not specifically limited, but is preferably 10° to 80°, more preferably 20° to 50°, for example.

The inclined angle θ1 of less than 10° makes it difficult to cause the air bubbles to move from the one end 23a side to the other end 23b side. To the contrary, the inclined angle θ1 of 10° or more facilitates moving the air bubbles upward (that is, toward the release hole 35). Therefore, it is made surer that the air bubbles are easily released through the release hole 35. On the other hand, the inclined angle θ1 of more than 80° makes it difficult to cause the air bubbles that have moved toward the other end 23b side to move further to a position where the release hole 35 is formed on the other end 23b side. To the contrary, the inclined angle θ1 of not more than 80° makes it surer that the air bubbles easily reach the release hole 35 formed through a second cover 29 when they arrive at the second cover 29. Therefore, it is made surer that the air bubbles are easily released through the release hole 35.

The filter 21 is configured to filter the coating liquid 3.

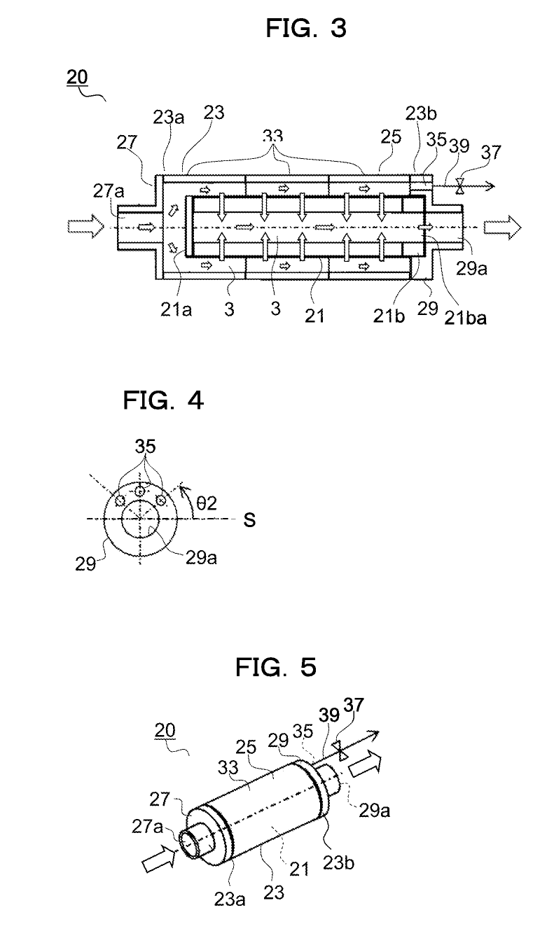

The filter 21 is formed into a cylindrical shape, including an end (end on the closed side) 21a without having an opening, and an end (end on the open side) 21b having the opening 21ba. Further, the filter is configured to filter the coating liquid 3 through its lateral face (circumferential surface) from the outside to the inside (see white arrows in FIG. 3).

Examples of the filter 21 include a depth filter, a pleated filter, and a membrane filter.

The outer diameter and length of the filter 21 are appropriately set. For example, depending on the viscosity of the coating liquid 3, the length of the filter 21 is set. Specifically, for example, when the viscosity of the coating liquid 3 is comparatively high, the length of the filter 21 can be set to a comparatively large value, whereas when the viscosity of the coating liquid 3 is comparatively low, the length of the filter 21 can be set to a comparatively small value.

The housing 23 is configured, while housing the filter 21, to provide a space for the filter 21 to filter the coating liquid 3.

In the embodiments shown in FIG. 2 and FIG. 3, the housing 23 has a cylindrical body 25 that serves as the main body of the housing 23, and a first cover 27 and the second cover 29 that respectively close both ends of the body 25. That is, the housing 23 has the first cover 27 at the one end 23a and has the second cover 29 at the other end 23b.

Further, the housing 23 has, in the first cover 27, the inlet port 27a through which the coating liquid 3 is introduced therein, and has, in the second cover 29, the outlet port 29a through which the coating liquid 3 filtered by the filter 21 is discharged therefrom. The filter 21 is attached to the second cover 29 so that the opening 21ba and the outlet port 29a communicate with each other. Further, the release hole 35 for releasing the air is formed through the second cover 29 at a position outside the filter 21 of the second cover 29.

It should be noted that the filter unit of the present invention may employ an embodiment in which the housing does not have such covers.

The body 25 is composed of tubular members 33 that are connectable to each other. Specifically, the body 25 in FIG. 3 is formed by connecting a plurality of cylindrical members 33 having the same circular shape. Further, the body 25 in FIG. 5 is composed of one cylindrical member 33.

As shown in FIG. 3, when the body 25 is composed of three tubular members 33, the three tubular members 33 are connected to each other, and the first cover 27 and the second cover 29 are fixed respectively to both ends of the connected body thus obtained. Further, as shown in FIG. 5, when the body 25 is composed of one tubular member 33, the first cover 27 and the second cover 29 are fixed respectively to both ends of this tubular member 33.

It should be noted that the first cover 27 and the second cover 29 are each fixed to the tubular member 33, for example, by clamping or screwing.

In this way, the body 25 composed of the tubular members 33 that are connectable to each other allows the length of the body 25, that is, the length of the housing 23 to be changed corresponding to the length of the filter 21. This eliminates the need to separately produce another body of the integrated object corresponding to the length of the filter 21, and therefore the unnecessary cost or work in production of the housing 23 is omitted.

Further, as shown in FIG. 3, the inlet port 27a that allows the coating liquid 3 to be introduced into a region outside the filter 21 within the housing 23 is formed at the center of the first cover 27 at a position inside (i.e., at a position closer to the center axis than) the peripheral edge of the end 21a of the filter 21. The size of the inlet port 27a can be appropriately set depending on the amount of the coating liquid 3 to be delivered by the pump 7 or the pressure applied inside the housing 23.

Further, a space to allow the coating liquid 3 to move is formed between the first cover 27 and the end 21a of the filter 21.

The end 21b of the filter 21 is attached to the second cover 29. Thereby, the second cover 29 supports the filter 21. The end 21b of the filter 21 is attached to the second cover 29, for example, by fixation using a twist lock mechanism.

The outlet port 29a through which the coating liquid 3 filtered by the filter 21 is discharged is formed at the center of the second cover 29 at a position inside (i.e., at a position closer to the center axis than) the end 21b of the filter 21. The size of the outlet port 29a can be appropriately set depending on the amount of the coating liquid 3 that has passed through the filter 21, the amount of the coating liquid 3 after being filtered to be delivered to the coater 13, or the pressure applied inside the filter 21.

The release hole 35 having a circular shape through which air is released is formed on the peripheral edge side of the second cover 29 at a position outside the filter 21.

The shape and size of the release hole 35 are not specifically limited, and can be appropriately set depending on the air bubble generation state within the housing 23.

The arrangement of the release hole 35 is also not specifically limited. However, considering that the air bubbles tend to gather when the filter unit 20 is arranged inclined, as shown in FIG. 2, it is preferable that the release hole 35 be formed on the peripheral edge side of the second cover 29 rather than on the center side thereof.

Further, the number of the release hole 35 is also not specifically limited. For example, a plurality of release holes 35, more specifically, three release holes 35 may be formed, as shown in FIG. 4, along the peripheral edge of the second cover 29.

In the case where a plurality of release holes 35 are formed as above, the plurality of release holes 35 are preferably arranged on the same side of the imaginary plane S (or an imaginary line extending along the diameter of the second cover 29) that is parallel to the horizontal plane. More specifically, the plurality of release holes 35 are preferably arranged above the imaginary plane S. Such arrangement allows air bubbles to be released more easily through the release holes 35.

Further, in the case where the plurality of release holes 35 are formed, it is preferable that the release holes each have an angle θ2 of at least 45° with respect to the imaginary plane S. That is, the release hole 35 located at the lowest position preferably has the angle θ2 of at least 45° with respect to the imaginary plane S.

Also, in the case where one release hole 35 is formed, it is preferable that the release hole 35 be arranged above the imaginary plane S, it is more preferable that the release hole 35 have the angle θ2 of at least 45° with respect to the imaginary plane S, and it is further preferable that the release hole 35 be located at the highest position.

When the inclined angle θ2 is at least 45°, there is an advantage that the air bubbles are released easily.

The conduit 39 forms a moving path of air bubbles released through the release hole 35 of the filter unit 20. Examples of the conduit 39 include a tube made of resin.

Further, the valve 37 is configured to close the conduit 39 until the amount of air bubbles released from the release hole 35 of the filter unit 20 into the conduit 39 reaches a specific value, and to open the conduit 39 when the amount thereof has reached the specific value. When the valve 37 is open, the air bubbles are further released to the outside of the unit.

It should be noted that air bubbles are normally released together with a part of the coating liquid 3 through the release hole 35, and the coating liquid 3 containing the air bubbles may be drained into a drainage tank, which is not shown, or may be returned to the reservoir 5 to be used again.

According to the aforementioned coating apparatus 1, when the coating liquid 3 is delivered by the pump 7 from the reservoir 5 to the filter unit 20 via the conduit 15, the coating liquid 3 is introduced into the housing 23 through the inlet port 27a on the one end 23a side of the housing 23, so as to fill the housing 23 while moving toward the other end 23b side around the periphery of the filter 21. Simultaneously with this, the coating liquid 3 is filtered from the outside to the inside of the filter 21. At this time, even if air bubbles are entrained in the coating liquid 3 moving around the periphery of the filter 21, the air bubbles are moved upward (obliquely upward herein) toward the second cover 29, up to the uppermost side along the inner surface of the second cover 29, due to the flow of the coating liquid 3 and their specific gravity that is smaller than that of the coating liquid. Further, the air bubbles contained in the coating liquid that has been introduced below the filter 21 among the coating liquid 3 introduced through the inlet port 27a move toward the release hole 35, due to their buoyancy, together with the flow of the coating liquid 3, while moving from below to above the filter 21.

The air bubbles that have moved to the uppermost side, or those that have moved there and gathered together, are released through the release hole 35 into the conduit 39, and then to the outside of the unit by opening the valve 37.

In this way, while air bubbles are removed, the coating liquid 3 that has been filtered from the outside to the inside of the filter 21 is discharged through the outlet port 29a of the second cover 29, so as to be delivered to the coater 13 via the conduit 15. Then, the coater 13 applies the coating liquid 3 to the sheet 11 that is relatively moving along the longitudinal direction while being supported by the supporting part 9, so that the coating film 40 is formed.

Further, in the method for producing a coating film, using the aforementioned coating apparatus 1 of this embodiment, the coating liquid 3 is filtered by the filter unit 20, and the coating liquid 3 after being filtered is applied to the sheet 11 having a strip shape that is relatively moving along the longitudinal direction, so that the coating film 40 is formed.

As has been described above, the filter unit 20 of this embodiment includes: the filter 21 that filters the coating liquid 3 to be applied to the sheet 11; and the housing 23 that houses the filter 21, wherein the filter 21 has the opening 21ba on the end 21b side, and is configured to filter the coating liquid 3 from the outside to the inside of the filter 21, the housing 23 has, on the one end 23a side, the inlet port 27a through which the coating liquid 3 is introduced, and has, on the other end 23b side, the outlet port 29a through which the coating liquid 3 filtered by the filter 21 is discharged, the filter 21 is attached to the other end 23b side of the housing so that the opening 21ba and the outlet port 29a communicate with each other, and the release hole 35 through which air is released is formed outside the filter 21 on the other end 23b side of the housing.

According to the filter unit 20 with such a configuration, it is possible to arrange the filter unit 20 so that the other end 23b side of the housing 23 is located above the one end 23a side thereof. This exerts the following action. That is, the coating liquid 3 introduced through the inlet port 27a of the housing 23 flows upward outside the filter 21 within the housing 23. With this flow, the coating liquid 3 after being filtered from the outside to the inside of the filter 21 can be discharged through the outlet port 29a of the housing 23, while air is moved to the other end side 23b. At this time, the air moved to the other end 23b side can be released through the release hole 35.

In this way, while the coating liquid 3 moving upward is filtered by the filter 21 from the outside to the inside, the air entrained in the coating liquid 3 before being filtered can be released through the release hole 35 by being pushed upward to the other end 23b side due to the flow of the coating liquid 3 and the specific gravity of the air that is smaller than that of the coating liquid 3, without being pushed downward so that the flow (buoyancy of the air) is hindered.

Accordingly, air bubbles are more easily removed than in conventional techniques.

Further, the coating apparatus of this embodiment includes the filter unit 20, and the coater 13 that forms the coating film 40 by applying the coating liquid 3 filtered by the filter unit 20 to the sheet 11, wherein the filter unit 20 is arranged so that the other end 23b side of the housing 23 is located above the one end 23a side thereof.

Such a configuration includes the filter unit 20 arranged so that the other end 23b side of the housing 23 is located above the one end 23a side, and thus enables the filtered coating liquid 3 to be applied to a sheet while air bubbles are easily removed from the coating liquid 3.

Further, air entrainment or thickness variation from a desired value can be suppressed, and therefore formation of the coating film 40 with reduced quality can be suppressed.

Further, the method for producing a coating film of this embodiment uses the coating apparatus 1, wherein the coating liquid is filtered by the filter unit 20, and the filtered coating liquid 3 is applied to the sheet 11, so that the coating film 40 is formed.

Such a configuration allows the filtration of the coating liquid 3 by the filter unit 20 arranged so that the other end 23b side of the housing 23 is located above the one end 23a side thereof, and therefore enables the filtered coating liquid 3 to be applied to the sheet 11 while air bubbles are easily removed from the coating liquid 3.

This enables the filtered coating liquid 3 to be applied to the sheet 11 while air bubbles are easily removed from the coating liquid 3. Further, air entrainment or thickness variation from a desired value can be suppressed. Therefore, formation of the coating film 40 with reduced quality can be suppressed.

As has been described above, this embodiment can provide the filter unit 20 from which air bubbles are removed more easily than in conventional techniques. Further, the aforementioned embodiments can provide the coating apparatus 1 and the method for producing the coating film 40 that are capable of applying coating while removing air bubbles more easily than in conventional techniques, and capable of suppressing formation of the coating film 40 with reduced quality.

Further, in the filter unit 20, the coating apparatus 1, and the method for producing a coating film of these embodiments, the viscosity of the coating liquid 3 is suitably 0.001 to 500 Pa·s. Such viscosity, for example, is a value measured by a concentric double cylinder rotational viscometer, a single cylinder rotational viscometer, or a cone-and-plate rotational viscometer. Particularly when the viscosity of the coating liquid 3 is 0.5 to 500 Pa·s, it is made difficult to cause air bubbles to move within the coating liquid 3. However, according to the filter unit 20, the coating apparatus 1, and the method for producing a coating film of these embodiments, the air bubbles are moved inside the housing 23 together with the flow of the coating liquid 3, so that the thus moved air bubbles can be released through the release hole 35. Accordingly, the filter unit 20, the coating apparatus 1, and the method for producing a coating film of these embodiments are made more useful.

The filter unit, the coating apparatus, and the method for producing a coating film of these embodiments are as described above. However, the present invention is not limited to these embodiments, and the design can be appropriately modified within the scope intended by the present invention.

What is claimed is:

1. A filter unit comprising:
a filter configured to filter a coating liquid to be applied to a sheet; and
a housing configured to house the filter, wherein
the filter has an opening on one end side and is configured to filter the coating liquid from the outside to the inside of the filter,
the housing has, on one end side, an inlet port through which the coating liquid is introduced, and has, on the other end side, an outlet port through which the coating liquid filtered by the filter is discharged,
the filter is attached to the other end side of the housing so that the opening and the outlet port communicate with each other, and
the housing has a release hole through which air is released, the release hole being formed on the other end side outside the filter.

2. A coating apparatus comprising:
the filter unit according to claim 1; and
a coater configured to form a coating film by applying a coating liquid filtered by the filter unit to the sheet, wherein
the filter unit is arranged so that the other end side of the housing is located above the one end side of the housing.

3. A method for producing a coating film comprising:
filtering a coating liquid by the filter unit; and forming a coating film by applying the filtered coating liquid to a sheet, using the coating apparatus according to claim 2.
